(19) United States
(12) Patent Application Publication
(10) Pub. No.: US 2017/0048292 A1
(43) Pub. Date: Feb. 16, 2017

(54) ELECTRONIC DEVICE AND METHOD FOR PROVIDING CONTENT

(71) Applicant: Samsung Electronics Co., Ltd., Suwon-si (KR)

(72) Inventors: Wooyong LEE, Hwaseong-si (KR); Jaechul KIM, Seoul (KR); Sangho NOH, Seoul (KR); Jooyoung JUNG, Goyang-si (KR); Inpyo LEE, Bucheon-si (KR); Kihuk LEE, Suwon-si (KR)

(21) Appl. No.: 15/234,589

(22) Filed: Aug. 11, 2016

(30) Foreign Application Priority Data
Aug. 12, 2015 (KR) 10-2015-0114179

(51) Int. Cl. H04L 29/06; H04L 29/08; H04W 4/00

(52) U.S. Cl. CPC H04L 65/4076; H04L 65/60; H04W 4/008; H04L 67/02; H04L 65/608; H04L 67/42; H04W 84/12

(57) ABSTRACT

An electronic device for providing content is provided. The electronic device includes a communication transceiver, a memory, and a processor, in which the processor may be configured to establish a connection to an external electronic device through the communication transceiver, based on at least a first input, transmit a request for broadcasting and content to the external electronic device, based on at least a second input, and synchronize the electronic device with the external electronic device in association with the broadcasting of the content, based on a reception of a response that at least a part of the content is received from the external electronic device.

### CROSS-REFERENCE TO RELATED APPLICATION(S)

This application claims the benefit under 35 U.S.C. §119(a) of a Korean patent application filed on Aug. 12, 2015 in the Korean Intellectual Property Office and assigned Serial number 10-2015-0114179, the entire disclosure of which is hereby incorporated by reference.

### TECHNICAL FIELD

The present disclosure relates to an electronic device and a method for providing content. More particularly, the present disclosure relates to an electronic device and a method for easily sharing content by a user input.

### BACKGROUND

A mobile terminal may be configured to perform various functions. An example of various functions includes a data and voice communication function, a function of photographing a picture or a moving image through a camera, a voice storing function, a function of playing a music file through a speaker system, a function of displaying an image or a video, and the like.

Further, a recent mobile terminal may receive a broadcasting or multicast signal to view a video or a television program.

Further, the mobile terminal provides a personal broadcasting function that may transmit a pre-stored image or an image (video signal) photographed by a camera to an opponent terminal through a server providing a broadcasting service in real time.

The above information is presented as background information only to assist with an understanding of the present disclosure. No determination has been made, and no assertion is made, as to whether any of the above might be applicable as prior art with regard to the present disclosure.

### SUMMARY

When image content is transmitted from a mobile terminal to another mobile terminal, complicated processes of accessing a server for providing broadcasting for the content, setting an address to which the image content will be provided, performing photographing setting such as camera driving and a composition, issuing an image transmission command, and the like are required. As a result, there is a problem in that it is difficult for a user to start to transmit image content and it takes a user much time to start to transmit the image content.

Aspects of the present disclosure are to address at least the above-mentioned problems and/or disadvantages and to provide at least the advantages described below. Accordingly, an aspect of the present disclosure is to provide an electronic device and a method for easily sharing content by a user input.

In accordance with an aspect of the present disclosure an electronic device for providing content is provided. The electronic device includes a communication transceiver, a memory, and a processor, in which the processor may be configured to establish a connection to an external electronic device through the communication transceiver, based on at least a first input, transmit a request for broadcasting and content to the external electronic device, based on at least a second input, and synchronize the electronic device with the external electronic device in association with the broadcasting of the content, based on a reception of a response that at least a part of the content is received from the external electronic device.

The processor may be further configured to transmit a broadcasting generation message to the external electronic device, as at least a part of an establishment and receive first link information for broadcasting and second link information for receiving the broadcasting, as at least a part of a response to the broadcasting generation message from the external electronic device.

The processor may be further configured to update time information of the electronic device based on time information of the external electronic device, as at least a part of a synchronization operation.

The processor may be further configured to store the content or another content associated with the content in the memory, based on at least the reception of the response.

The electronic device may further include: at least one input device for acquiring the content or the another content.

The processor may be further configured to transmit broadcasting information corresponding to the broadcasting to another external electronic device, based on a reception of a broadcasting preparation complete message from the external electronic device.

The processor may be further configured to transmit link information accessing the broadcasting to the another external electronic device, as at least a part of the broadcasting information.

The processor may be further configured to select another external electronic device based on at least third input and transmit information corresponding to the broadcasting to the another external electronic device.

The reception of the response may include information corresponding to at least a part of the content that the external electronic device starts to broadcast or timer information that the external electronic device is used to broadcast.

The electronic device may include a display and the processor may be further configured to receive feedback information on the content from another electronic device through the external electronic device and display the content, the feedback information, and a combination thereof through the display.

In accordance with an aspect of the present disclosure, a method of operating an electronic device is provided. The method includes establishing a connection to an external electronic device through a communication transceiver functionally connected to the electronic device, based on at least a first input, transmitting a request for broadcasting and content to the external electronic device, based on at least a second input, and synchronizing the electronic device with the external electronic device in association with the broadcasting of the content, based on a reception of a response that at least a part of the content is received from the external electronic device.

In accordance with an aspect of the present disclosure, a non-transitory computer readable recording medium with an executable program stored thereon is provided. The program instructs a processor to perform the operations, which include establishing a connection to an external electronic device through a communication transceiver functionally connected to an electronic device, based on at least a first input, transmitting a request for broadcasting and content to the external electronic device, based on at least a second input; and synchronizing the electronic device with the external electronic device in association with the broadcasting of the content, based on a reception of a response that at least a part of the content is received from the external electronic device.

In accordance with another aspect of the present disclosure, a method for operating an electronic apparatus is provided. The method includes establishing a connection to an external electronic device through a communication module functionally connected to the electronic device, based on at least first input, transmitting a request for broadcasting and content to the external electronic device, based on at least second input, and synchronizing the electronic device with the external electronic device in association with the broadcasting of the content, based on a reception of a response that at least a part of the content is received from the external electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device according to an embodiment of the present disclosure;

FIG. 2 is a block diagram of the electronic device according to an embodiment of the present disclosure;

FIG. 3 is a block diagram of a program module according to an embodiment of the present disclosure;

FIG. 4 is a diagram for describing a process of providing content from an electronic device according to an embodiment of the present disclosure;

FIG. 5 is a detailed block diagram of an electronic device illustrated in FIG. 4 according to an embodiment of the present disclosure;

FIG. 6 is a data flow chart illustrating the process of providing content from an electronic device according to an embodiment of the present disclosure;

FIGS. 7A, 7B, 7C, 7D, 7E, and 7F are diagrams for describing a method for sharing content of an electronic device according to various embodiments of the present disclosure;

FIG. 8 is a diagram for describing a method for selecting at least electronic device transmitting an invite message according to an embodiment of the present disclosure;

FIG. 9 is a diagram illustrating an invite message according to an embodiment of the present disclosure;

FIG. 10 is a flow chart for describing a method for sharing content of an electronic device according to an embodiment of the present disclosure; and

FIG. 11 is a flow chart for describing an operation of an electronic device when a content stop event is generated according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An expression “comprising” or “may comprise” used in the present disclosure indicates presence of a corresponding function, operation, or element and does not limit additional at least one function, operation, or element. Further, in the present disclosure, a term “comprise” or “have” indicates presence of a characteristic, numeral, step, operation, element, component, or combination thereof described in a specification and does not exclude presence or addition of at least one other characteristic, numeral, step, operation, element, component, or combination thereof.

In the present disclosure, an expression “or” includes any combination or the entire combination of together listed words. For example, “A or B” may include A, B, or A and B.

An expression of a first and a second in the present disclosure may represent various elements of the present disclosure, but do not limit corresponding elements. For example, the expression does not limit order and/or importance of corresponding elements. The expression may be used for distinguishing one element from another element. For example, both a first user device and a second user device are user devices and represent different user devices. For example, a first constituent element may be referred to as a second constituent element without deviating from the scope of the present disclosure, and similarly, a second constituent element may be referred to as a first constituent element.

When it is described that an element is “coupled” to another element, the element may be “directly coupled” to the other element or “electrically coupled” to the other element through a third element. However, when it is described that an element is “directly coupled” to another element, no element may exist between the element and the other element.

Terms used in the present disclosure are not to limit the present disclosure but to illustrate various embodiments. When using in a description of the present disclosure and the appended claims, a singular form includes a plurality of forms unless it is explicitly differently represented.

Unless differently defined, entire terms including a technical term and a scientific term used here have the same meaning as a meaning that may be generally understood by a person of common skill in the art. It should be analyzed that generally using terms defined in a dictionary have a meaning corresponding to that of a context of related technology and are not analyzed as an ideal or excessively formal meaning unless explicitly defined.

In this disclosure, an electronic device may be a device that involves a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group phase 1 or phase 2 (MPEG-1 or MPEG-2) audio layer 3 (MP3) player, a portable medical device, a digital camera, or a wearable device (e.g., an head-mounted device (HMD) such as electronic glasses, electronic clothes, an electronic bracelet, an electronic necklace, an electronic accessory, or a smart watch).

According to some embodiments, an electronic device may be a smart home appliance that involves a communication function. For example, an electronic device may be a television (TV), a digital video disk (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame.

According to some embodiments, an electronic device may be a medical device (e.g., magnetic resonance angiography (MRA), magnetic resonance imaging (MRI), computed tomography (CT), ultrasonography, etc.), a navigation device, a global positioning system (GPS) receiver, an event data recorder (EDR), an flight data recorder (FDR), a car infotainment device, electronic equipment for ship (e.g., a marine navigation system, a gyrocompass, etc.), avionics, security equipment, or an industrial or home robot.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof.

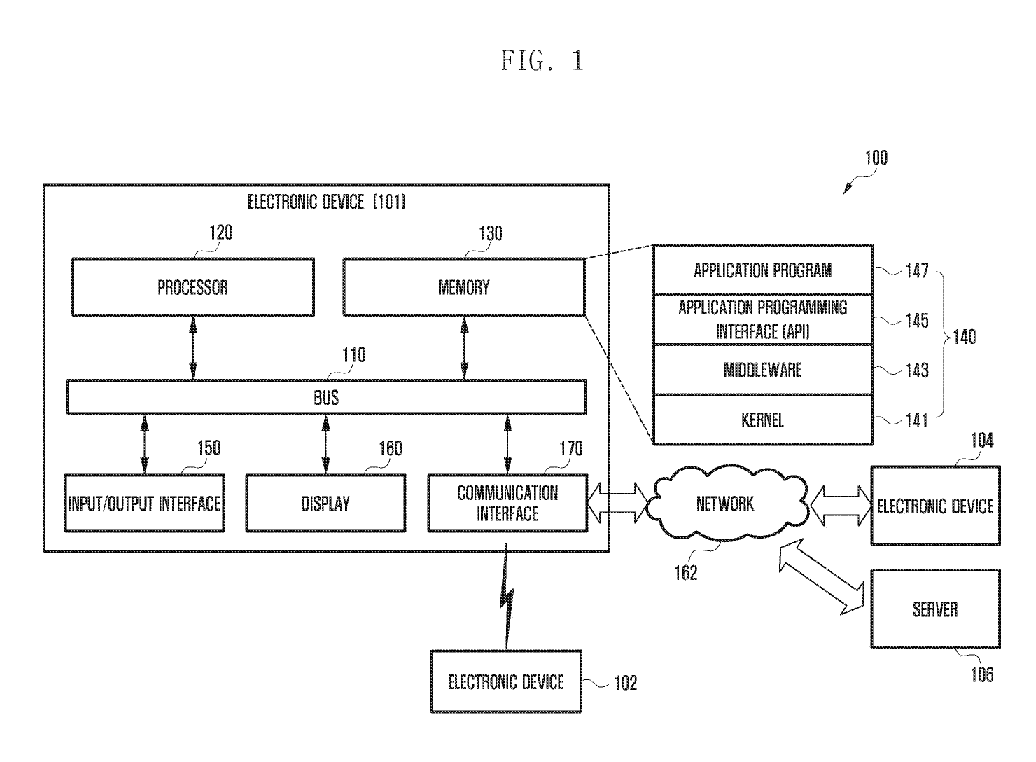

FIG. 1 is a block diagram 100 illustrating an electronic apparatus according to an embodiment of the present disclosure.

Referring to FIG. 1, the electronic apparatus 101 may include a bus 110, a processor 120, a memory 130, a user input module 150, a display 160, and a communication interface 170.

The bus 110 may be a circuit for interconnecting elements described above and for allowing a communication, e.g. by transferring a control message, between the elements described above.

The processor 120 can receive commands from the above-mentioned other elements, e.g. the memory 130, the user input module 150, the display 160, and the communication interface 170, through, for example, the bus 110, can decipher the received commands, and perform operations and/or data processing according to the deciphered commands.

The memory 130 can store commands received from the processor 120 and/or other elements, e.g. the user input module 150, the display 160, and the communication interface 170, and/or commands and/or data generated by the processor 120 and/or other elements. The memory 130 may include software and/or programs 140, such as a kernel 141, middleware 143, an application programming interface (API) 145, and an application 147. Each of the programming modules described above may be configured by software, firmware, hardware, and/or combinations of two or more thereof.

The kernel 141 can control and/or manage system resources, e.g. the bus 110, the processor 120 or the memory 130, used for execution of operations and/or functions implemented in other programming modules, such as the middleware 143, the API 145, and/or the application 147. Further, the kernel 141 can provide an interface through which the middleware 143, the API 145, and/or the application 147 can access and then control and/or manage an individual element of the electronic apparatus 101.

The middleware 143 can perform a relay function which allows the API 145 and/or the application 147 to communicate with and exchange data with the kernel 141. Further, in relation to operation requests received from at least one of an application 147, the middleware 143 can perform load balancing in relation to the operation requests by, for example, giving a priority in using a system resource, e.g. the bus 110, the processor 120, and/or the memory 130, of the electronic apparatus 101 to at least one application from among the at least one of the application 147.

The API 145 is an interface through which the application 147 can control a function provided by the kernel 141 and/or the middleware 143, and may include, for example, at least one interface or function for file control, window control, image processing, and/or character control.

The user input module 150 can receive, for example, a command and/or data from a user, and transfer the received command and/or data to the processor 120 and/or the memory 130 through the bus 110. The display 160 can display an image, a video, and/or data to a user.

The communication interface 170 can establish a communication between the electronic apparatus 101 and other electronic devices 102 and 104 and/or a server 106. The communication interface 170 can support short range communication protocols, e.g. a wireless fidelity (WiFi) protocol, a Bluetooth (BT) protocol, and a near field communication (NFC) protocol, communication networks, e.g. Internet, local area network (LAN), wide area network (WAN), a telecommunication network, a cellular network, and a satellite network, or a plain old telephone service (POTS), or any other similar and/or suitable communication networks, such as network 162, or the like. Each of the electronic devices 102 and 104 may be a same type and/or different types of electronic apparatus.

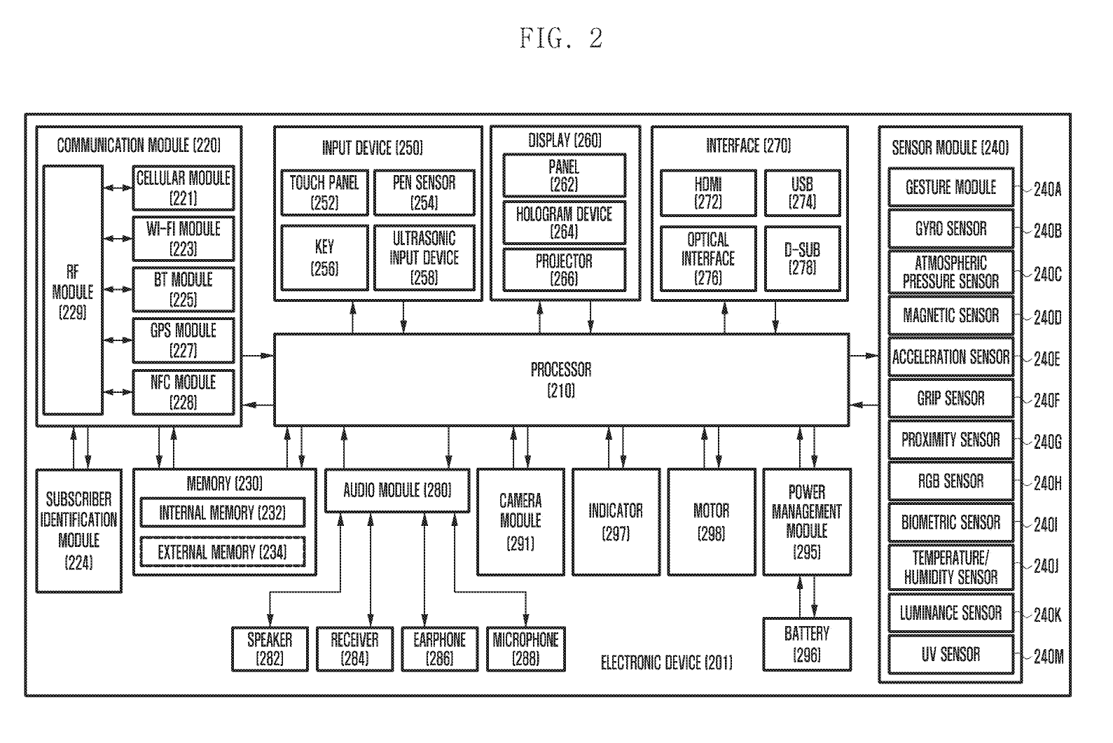

FIG. 2 is a block diagram illustrating an electronic device 201 according to an embodiment of the present disclosure.

Referring to FIG. 2, the electronic device 201 may form, for example, the whole or part of the electronic device 201 shown in FIG. 1. Referring to FIG. 2, the electronic device 201 may include at least one application processor (AP) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 may drive an operating system (OS) or applications, control a plurality of hardware or software components connected thereto, and also perform processing and operation for various data including multimedia data. The AP 210 may be formed of system-on-chip (SoC), for example. According to an embodiment, the AP 210 may further include a graphic processing unit (GPU) (not shown).

The communication module 220 (e.g., the communication interface 170) may perform a data communication with any other electronic device (e.g., the electronic device 104 or the server 106) connected to the electronic device 200 (e.g., the electronic device 101) through the network. According to an embodiment, the communication module 220 may include therein a cellular module 221, a WiFi module 223, a BT module 225, a GPS module 227, an NFC module 228, and a radio frequency (RF) module 229.

The cellular module 221 may offer a voice call, a video call, a message service, an internet service, or the like through a communication network (e.g., long term evolution (LTE), LTE advanced (LTE-A), code division multiple access (CDMA), wideband CDMA (WCDMA), universal mobile telecommunications system (UMTS), wireless broadband (WiBro), or global system for mobiles (GSM), etc.). Additionally, the cellular module 221 may perform identification and authentication of the electronic device in the communication network, using the SIM card 224. According to an embodiment, the cellular module 221 may perform at least part of functions the AP 210 can provide. For example, the cellular module 221 may perform at least part of a multimedia control function.

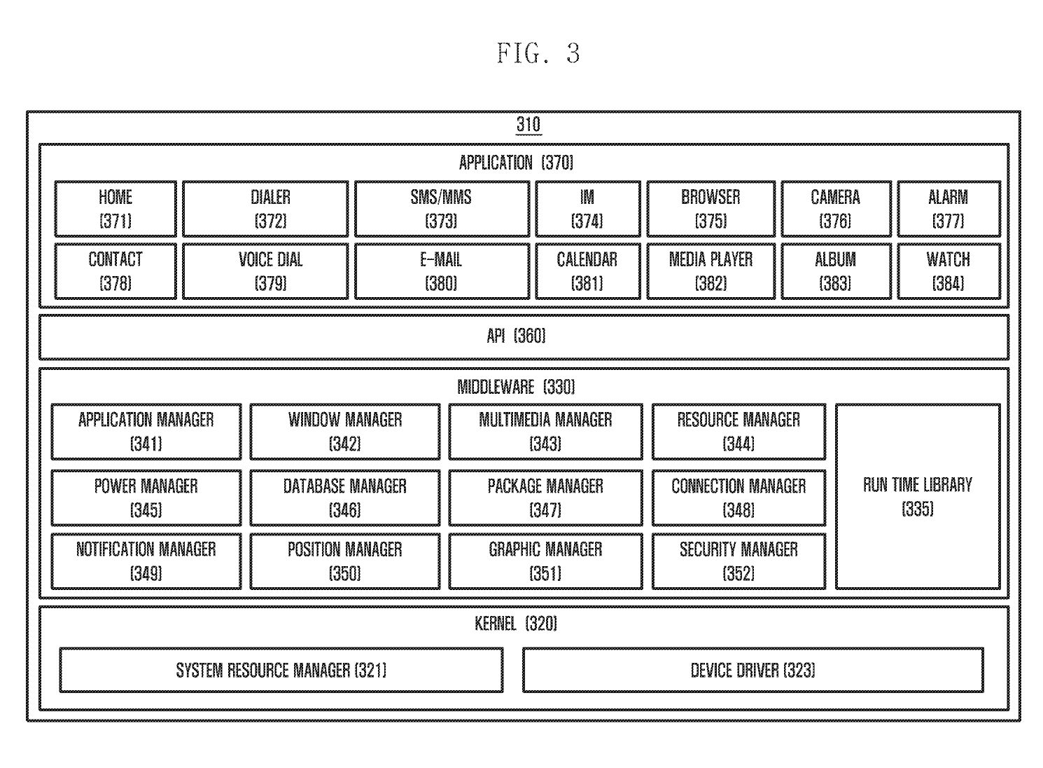

According to an embodiment, the cellular module 221 may include a communication processor (CP). Additionally, the cellular module 221 may be formed of SoC, for example. Although some elements such as the cellular module 221 (e.g., the CP), the memory 230, or the power management module 295 are shown as separate elements being different from the AP 210 in FIG. 3, the AP 210 may be formed to have at least part (e.g., the cellular module 221) of the above elements in an embodiment.

According to an embodiment, the AP 210 or the cellular module 221 (e.g., the CP) may load commands or data, received from a nonvolatile memory connected thereto or from at least one of the other elements, into a volatile memory to process them. Additionally, the AP 210 or the cellular module 221 may store data, received from or created at one or more of the other elements, in the nonvolatile memory.

Each of the WiFi module 223, the BT module 225, the GPS module 227 and the NFC module 228 may include a processor for processing data transmitted or received therethrough. Although FIG. 2 shows the cellular module 221, the WiFi module 223, the BT module 225, the GPS module 227 and the NFC module 228 as different blocks, at least part of them may be contained in a single integrated circuit (IC) chip or a single IC package in an embodiment. For example, at least part (e.g., the CP corresponding to the cellular module 221 and a WiFi processor corresponding to the WiFi module 223) of respective processors corresponding to the cellular module 221, the WiFi module 223, the BT module 225, the GPS module 227 and the NFC module 228 may be formed as a single SoC.

The RF module 229 may transmit and receive data, e.g., RF signals or any other electric signals. Although not shown, the RF module 229 may include a transceiver, a power amp module (PAM), a frequency filter, a low noise amplifier (LNA), or the like. Also, the RF module 229 may include any component, e.g., a wire or a conductor, for transmission of electromagnetic waves in a free air space. Although FIG. 3 shows that the cellular module 221, the WiFi module 223, the BT module 225, the GPS module 227 and the NFC module 228 share the RF module 229, at least one of them may perform transmission and reception of RF signals through a separate RF module in an embodiment.

The SIM card 224 may be a specific card formed of SIM and may be inserted into a slot formed at a certain place of the electronic device 201. The SIM card 224 may contain therein an integrated circuit card identifier (ICCID) or an international mobile subscriber identity (IMSI).

The memory 230 (e.g., the memory 130) may include an internal memory 232 and an external memory 234. The internal memory 232 may include, for example, at least one of a volatile memory (e.g., dynamic random aces memory (DRAM), Static RAM (SRAM), synchronous DRAM (SDRAM), etc.) or a nonvolatile memory (e.g., one time programmable read only memory (OTPROM), programmable ROM (PROM), erasable and programmable ROM (EPROM), electrically erasable and programmable ROM (EEPROM), mask ROM, flash ROM, NAND flash memory, NOR flash memory, etc.).

According to an embodiment, the internal memory 232 may have the form of a solid state drive (SSD). The external memory 234 may include a flash drive, e.g., compact flash (CF), secure digital (SD), micro secure digital (Micro-SD), mini secure digital (Mini-SD), eXtreme Digital (xD), memory stick, or the like. The external memory 334 may be functionally connected to the electronic device 201 through various interfaces. According to an embodiment, the electronic device 301 may further include a storage device or medium such as a hard drive.

The sensor module 240 may measure physical quantity or sense an operating status of the electronic device 201, and then convert measured or sensed information into electric signals. The sensor module 240 may include, for example, at least one of a gesture sensor 240A, a gyro sensor 240B, an atmospheric sensor 240C, a magnetic sensor 240D, an acceleration sensor 240E, a grip sensor 240F, a proximity sensor 240G, a color sensor 240H (e.g., red, green, blue (RGB) sensor), a biometric sensor 240I, a temperature-humidity sensor 240J, an illumination sensor 240K, and a ultraviolet (UV) sensor 240M. Additionally or alternatively, the sensor module 240 may include, e.g., an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris scan sensor (not shown), or a finger scan sensor (not shown). Also, the sensor module 340 may include a control circuit for controlling one or more sensors equipped therein.

The input device 250 may include a touch panel 252, a digital pen sensor 254, a key 256, or an ultrasonic input unit 258. The touch panel 252 may recognize a touch input in a manner of capacitive type, resistive type, infrared type, or ultrasonic type. Also, the touch panel 252 may further include a control circuit. In case of a capacitive type, a physical contact or proximity may be recognized. The touch panel 252 may further include a tactile layer. In this case, the touch panel 252 may offer a tactile feedback to a user.

The digital pen sensor 254 may be formed in the same or similar manner as receiving a touch input or by using a separate recognition sheet. The key 256 may include, for example, a physical button, an optical key, or a keypad. The ultrasonic input unit 258 is a specific device capable of identifying data by sensing sound waves with a microphone 288 in the electronic device 201 through an input tool that generates ultrasonic signals, thus allowing wireless recognition. According to an embodiment, the electronic device 201 may receive a user input from any external device (e.g., a computer or a server) connected thereto through the communication module 220.

The display 260 (e.g., the display 160) may include a panel 262, a hologram 264, or a projector 266. The panel 262 may be, for example, liquid crystal display (LCD), active matrix organic light emitting diode (AM-OLED), or the like. The panel 262 may have a flexible, transparent or wearable form. The panel 262 may be formed of a single module with the touch panel 252. The hologram 264 may show a stereoscopic image in the air using interference of light. The projector 266 may project an image onto a screen, which may be located at the inside or outside of the electronic device 201. According to an embodiment, the display 260 may further include a control circuit for controlling the panel 262, the hologram 264, and the projector 266.

The interface 270 may include, for example, a high-definition multimedia interface (HDMI) 272, a universal serial bus (USB) 274, an optical interface 276, or a D-subminiature (D-sub) 278. The interface 270 may be contained, for example, in the communication interface 170 shown in FIG. 1. Additionally or alternatively, the interface 270 may include, for example, a mobile high-definition link (MHL) interface, an SD card/multi-media card (MMC) interface, or an Infrared Data Association (IrDA) interface.

The audio module 280 may perform a conversion between sounds and electric signals. The audio module 280 may process sound information inputted or outputted through a speaker 282, a receiver 284, an earphone 286, or a microphone 288.

The camera module 291 is a device capable of obtaining still images and moving images. According to an embodiment, the camera module 291 may include at least one image sensor (e.g., a front sensor or a rear sensor), a lens (not shown), an ISP image signal processor (ISP) (not shown), or a flash (e.g., light emitting diode (LED) or xenon lamp, not shown).

The power management module 295 may manage electric power of the electronic device 201. Although not shown, the power management module 295 may include, for example, a power management integrated circuit (PMIC), a charger IC, or a battery or fuel gauge.

The PMIC may be formed, for example, of an IC chip or SoC. Charging may be performed in a wired or wireless manner. The charger IC may charge a battery 296 and prevent overvoltage or overcurrent from a charger. According to an embodiment, the charger IC may have a charger IC used for at least one of wired and wireless charging types. A wireless charging type may include, for example, a magnetic resonance type, a magnetic induction type, or an electromagnetic type. Any additional circuit for a wireless charging may be further used such as a coil loop, a resonance circuit, or a rectifier.

The battery gauge may measure the residual amount of the battery 296 and a voltage, current or temperature in a charging process. The battery 296 may store or create electric power therein and supply electric power to the electronic device 201. The battery 296 may be, for example, a rechargeable battery or a solar battery.

The indicator 297 may show thereon a current status (e.g., a booting status, a message status, or a recharging status) of the electronic device 201 or of its part (e.g., the AP 210). The motor 298 may convert an electric signal into a mechanical vibration. Although not shown, the electronic device 301 may include a specific processor (e.g., GPU) for supporting a mobile TV. This processor may process media data that comply with standards of digital multimedia broadcasting (DMB), digital video broadcasting (DVB), or media flow.

Each of the above-discussed elements of the electronic device disclosed herein may be formed of one or more components, and its name may be varied according to the type of the electronic device. The electronic device disclosed herein may be formed of at least one of the above-discussed elements without some elements or with additional other elements. Some of the elements may be integrated into a single entity that still performs the same functions as those of such elements before integrated.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of application-specific integrated circuit (ASIC) chip, field-programmable gate arrays (FPGAs), and programmable-logic device, which have been known or are to be developed.

FIG. 3 is a block diagram illustrating a configuration of a programming module 310 according to an embodiment of the present disclosure.

Referring to FIG. 3, the programming module 310 may be included (or stored) in the electronic device 301 (e.g., the memory 230) illustrated in FIG. 1 or may be included (or stored) in the electronic device 201 (e.g., the memory 230) illustrated in FIG. 2. At least a part of the programming module 310 may be implemented in software, firmware, hardware, or a combination of two or more thereof. The programming module 310 may be implemented in hardware, and may include an OS controlling resources related to an electronic device (e.g., the electronic device 101 or 201) and/or various applications (e.g., an application 370) executed in the OS. For example, the OS may be Android, iOS, Windows, Symbian, Tizen, Bada, and the like.

Referring to FIG. 3, the programming module 310 may include a kernel 320, a middleware 330, an API 360, and/or the application 370.

The kernel 320 (e.g., the kernel 211) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a BT driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 323 may include an inter-process communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 435 may perform functions which are related to input and output, the management of a memory, an arithmetic function, and/or the like.

The application manager 341 may manage, for example, a life cycle of at least one of the applications 370. The window manager 342 may manage graphical user interface (GUI) resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity manager 348 may manage a wireless connectivity such as, for example, Wi-Fi and BT. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 101) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 460 (e.g., the API 145) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 147) may include, for example, a preloaded application and/or a third party application. The applications 370 (e.g., the applications 147) may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 310 may be implemented by instructions stored in a non-transitory computer-readable storage medium. When the instructions are executed by one or more processors (e.g., the AP 210), the one or more processors may perform functions corresponding to the instructions. The non-transitory computer-readable storage medium may be, for example, the memory 230. At least a part of the programming module 310 may be implemented (e.g., executed) by, for example, the one or more processors. At least a part of the programming module 310 may include, for example, a module, a program, a routine, a set of instructions, and/or a process for performing one or more functions.

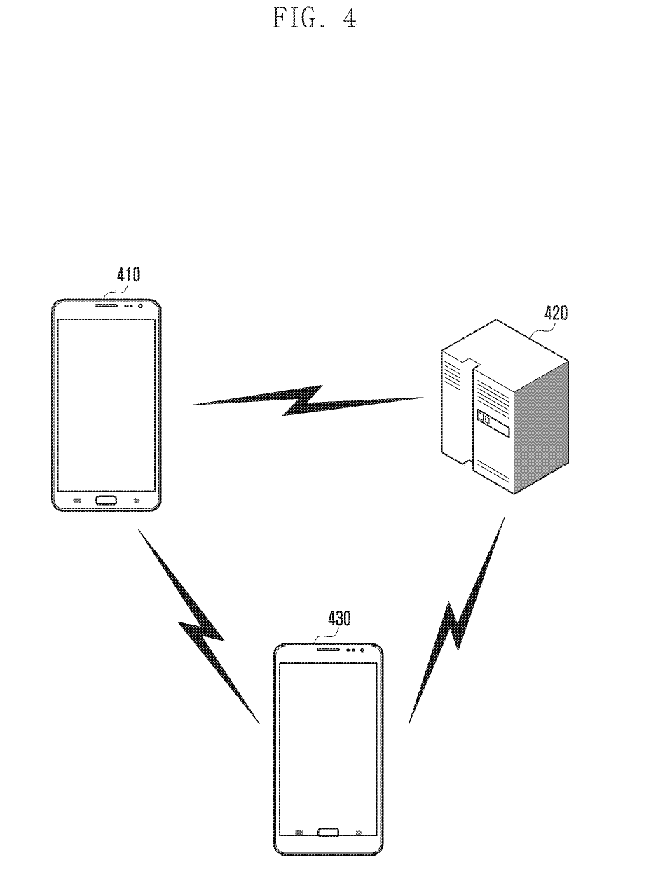

FIG. 4 is a diagram for describing a process of providing content from an electronic device according to an embodiment of the present disclosure.

Referring to FIG. 4, the first electronic device 410 includes a photographing device photographing an image and may transmit the video photographed by the photographing device to the server 420 and transmit an invite message to the second electronic device 430 to share the video with the second electronic device 430.

The server 420 may stream an image transmitted from the first electronic device 410 to the second electronic device 430. The server 420 may generate a session and transmit session information on the session to at least one of the first electronic device 410 and the second electronic device 430.

The session may mean a logical connection for communication between at least one of the first electronic device 410 and the second electronic device 430 and the server 420. The session information may mean a broadcasting uniform resource locator (URL) and an access URL and according to the embodiment, the access URL may be a real time messaging protocol (RTMP) URL.

The second electronic device 430 may receive the session information from the first electronic device 410 and receive a streaming image from the server 420. Although FIG. 4 illustrates the second electronic device 430 as one electronic device, according to the embodiment, the second electronic device 430 may mean a plurality of electronic devices. For example, the plurality of electronic devices may each receive the session information from the first electronic device 410 and receive the streaming image from the server 420.

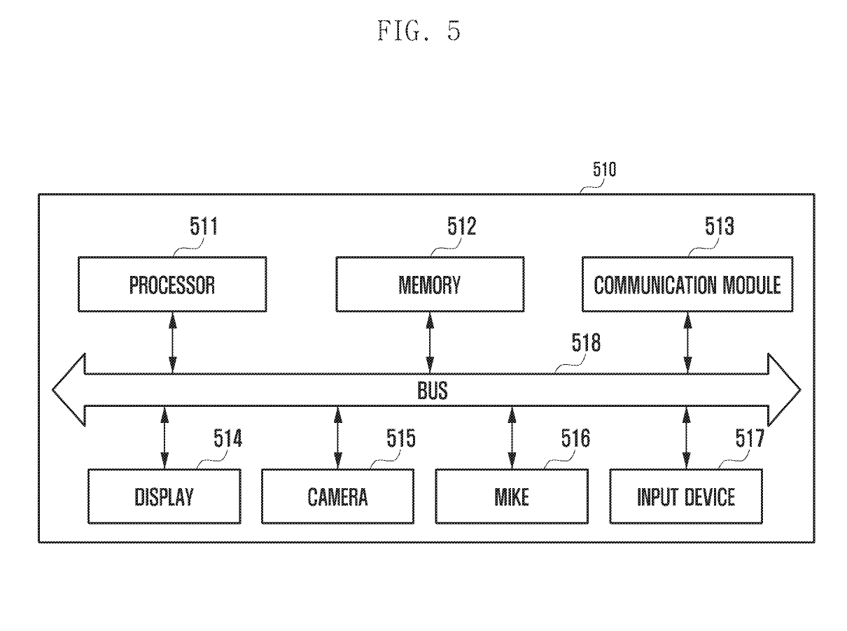

FIG. 5 is a detailed block diagram of an electronic device illustrated in FIG. 4 according to an embodiment of the present disclosure.

Referring to FIGS. 4 and 5, a first electronic device 510 includes a processor 511, a memory 512, a communication module 513, a display 514, a camera 515, a mike 516, an input device 517, and a bus 518. In this case, the modules 511 to 518 illustrated in FIG. 5 are associated with the modules illustrated in FIG. 2.

The processor 511 may include at least one of a central processing unit, an AP, and a CP. The processor 511 may perform, for example, an operation or data processing on a control and/or communication of at least one of the other components of the first electronic device 510.

The processor 511 may transmit a broadcasting generation message to the server 420 by a first input selecting a broadcasting mode and receive the broadcasting URL and the connection URL corresponding to the broadcasting generation message from the server 420. The processor 511 may transmit a broadcasting start message to the server 420 by a second input instructing a photographing start to the camera 515.

If the processor 511 receives a broadcasting data receiving message from the server 420, the processor 511 may perform a control to start a time update to meet a synchronization with the server 420 and store image data (or content) generated by the photographing.

The time update may mean that the first electronic device 510 controls timing while transmitting and receiving a relevant signal to the server 420 so that an elapse time of the broadcasting image may be matched with an elapse time of the broadcasting image displayed on the first electronic device 510.

The memory 512 may include a volatile and/or non-volatile memory. The memory 512 may store instructions to perform the operations of the processor 511. The memory 512 may store frame data generated by the photographing of the camera 515.

The communication module 513 may transmit and receive a signal to and from the server 420 or the second electronic device 430. The communication module 513 may communicate a signal with the server 420 or the second electronic device 530 through wireless communication or wired communication.

The display 514 may display, for example, various contents (for example: text, image, video, icon, and/or symbol, etc.) to a user.

The camera 515 is included in the first electronic device 510 and means the photographing device that may photograph broadcasting. According to another embodiment, the camera 515 may be implemented outside the first electronic device 510.

The mike 516 may process sound information input or output to or from the first electronic device 510. A first input selecting the broadcasting mode of the first electronic device 510, a second input instructing the photographing start to the camera 515, or a third input resuming broadcasting may be input to the input device 517.

The bus 518 may connect between the components 511 to 517 and may include a circuit providing communication (for example, control message or data) between the components.

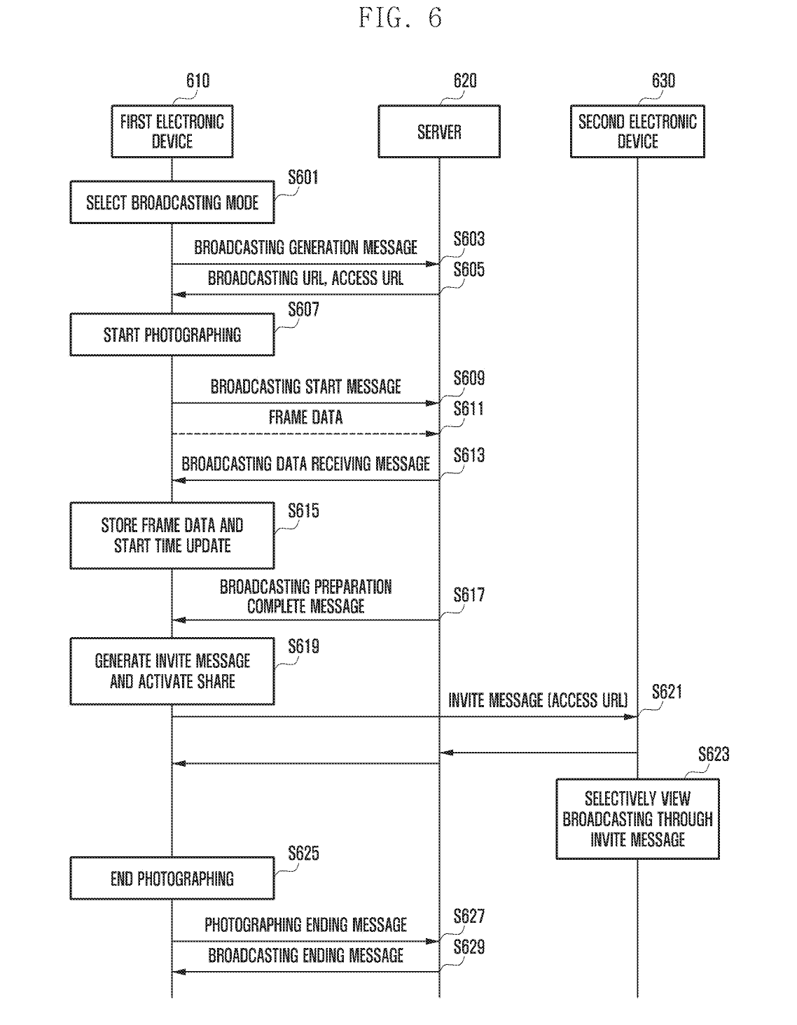

FIG. 6 is a data flow chart illustrating a process of providing broadcasting from an electronic device according to an embodiment of the present disclosure.

Referring to FIG. 6, a first electronic device 610 may select a broadcasting mode through a user interface provided through a display included in the first electronic device 610 at operation S601.

The first electronic device 610 may generate a broadcasting generation message by the first input selecting the broadcasting mode and transmit the broadcasting generation message to a server 620 at operation S603.

The server 620 may transmit the broadcasting URL and the access URL corresponding to the broadcasting generation message to the first electronic device 610 at operation S605. According to the embodiment, the access URL may be a RTMP URL.

The first electronic device 610 may drive the photographing device included in the first electronic device 610 to start photographing at operation S607, generate the broadcasting start message by the second input instructing the photographing start, and transmit the broadcasting start message to the server 620.

The first electronic device 610 may transmit the broadcasting start message to the server 620 at operation S609 and then transmit the frame data generated by the photographing to the server 620 at operation S611. The first electronic device 610 may transmit the frame data generated by the photographing to the server 620 until the photographing by the photographing device ends.

If the frame data are accumulated in the server 620 as much as a reference amount, the server 620 may transmit the broadcasting data receiving message to the first electronic device 610 at operation S613. In this case, the reference amount may be a preset value or a programmable value.

The server 620 may receive an image and then transmit frame information at the timing when the broadcasting is prepared to the first electronic device 610 and the server 620 may provide timer information to the first electronic device 610. In this case, the electronic device 610 may use the timer information based on time synchronization to know which frame of the image is broadcast and display it.

If the first electronic device 610 receives the broadcasting data receiving message from the server 620 at operation S613, the first electronic device 610 may start the time update for synchronizing with the server 620 and store the frame data from the timing when the broadcasting data receiving message is received to the memory included in the first electronic device 610 at operation S615.

The time update may mean that the first electronic device 610 controls timing while transmitting and receiving the relevant signal to the server 620 so that the elapse time of the broadcasting image may be matched with the elapse time of the broadcasting image displayed on the first electronic device 610.

If it is determined that the broadcasting preparation is completed based on the amount of frame data transmitted from the first electronic device 610, the server 620 may generate a broadcasting preparation complete message and transmit the broadcasting preparation complete message to the first electronic device 610 at operation S617. In this case, the amount of frame data may be the preset value or the programmable value.

The first electronic device 610 may generate the invite message for sharing broadcasting in response to the broadcasting preparation complete message transmitted from the server 620 and activate a share function for sharing the broadcasting at operation S619.

The invite message may be transmitted to at least one of other electronic devices. The share function may mean that the first electronic device 610 shares a broadcasting notification message through a social network service. According to the embodiment, the transmission of the invite message or the share function may be performed as a background work.

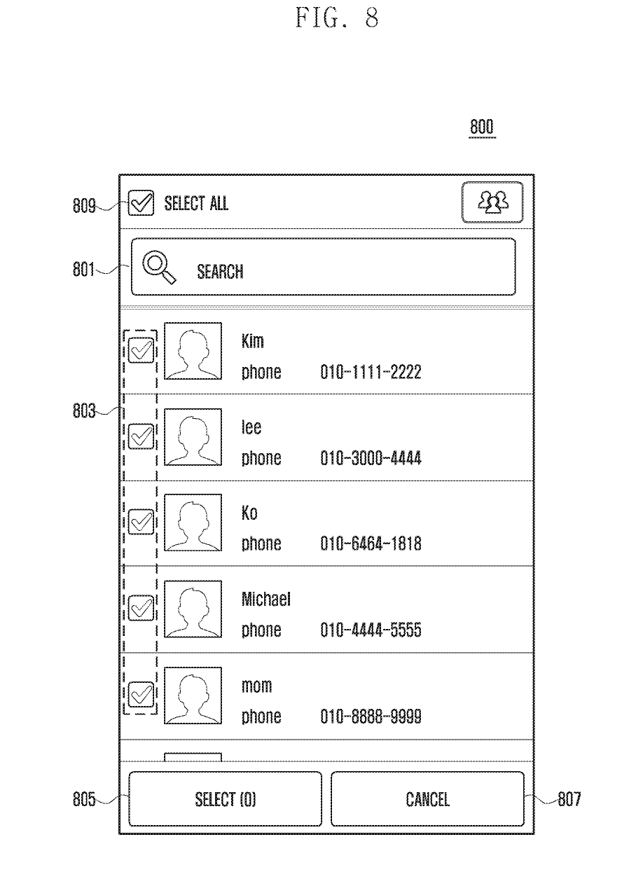

If a share button providing the share function is pressed, a contact program illustrated in FIG. 8 may be automatically popped-up or temporarily displayed by window division. Other users designated by the user input (for example, voice, touch, remote controller, or the like) among a plurality of contact information provided from the contact program may share an image. According to the embodiment, the contact program may be guided by a display and even an audio.

The first electronic device 610 may transmit the invite message to a second electronic device 630 to share the broadcasting by the first electronic device 610 with the second electronic device 630 at operation S621. The invite message may include the access URL for accessing the second electronic device 630 to the server 620. Although FIG. 6 illustrates that the second electronic device 630 is one electronic device, according to the embodiment, the second electronic device 630 may include a plurality of electronic devices and the first electronic device 610 may transmit the invite message to the plurality of electronic devices, respectively.

According to one embodiment, the invite message may automatically be transmitted to the second electronic device in response to the receiving of the broadcasting preparation complete message from the server 620. For example, when the condition information satisfies the designated condition (for example: the user of the second electronic device 630 is registered in the designated application (for example: instant messenger) as a friend), the broadcasting preparation complete message is received by the first electronic device 610 and then the invite message may be directly or indirectly (for example: via the server 620 or other external devices) transmitted to the second electronic device 630 without the additional input of the user.

According to the embodiment, additionally or generally, the invite message may be transmitted to the second electronic device 630 based on the user input (for example: touch, voice, gesture, or expression) received through the first electronic device 610.

The second electronic device 630 may selectively view the broadcasting by the first electronic device 610 through the invite message transmitted from the first electronic device 610 at operation S623. The second electronic device 630 may receive the streaming image from the server 620 through the access URL to the server 620 included in the invite message.

If the second electronic device 630 transmits a feedback for the streaming image received from the server 620, the first electronic device 60 may receive the feedback through the server 620. The feedback may be displayed in at least a part of the display of the first electronic device 610 and the feedback image as well as the original image may be stored in the first electronic device 610 or the server 620.

When the first electronic device 610 ends photographing at operation S625, the first electronic device 610 may transmit a photographing ending message to the server 620 at operation S627 and receive a broadcasting ending message corresponding to the photographing ending message from the server 620 at operation S629.

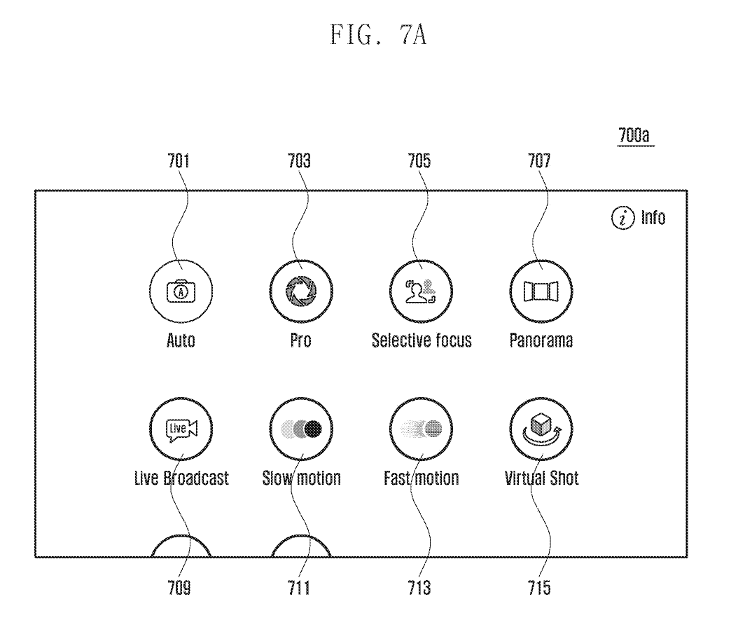

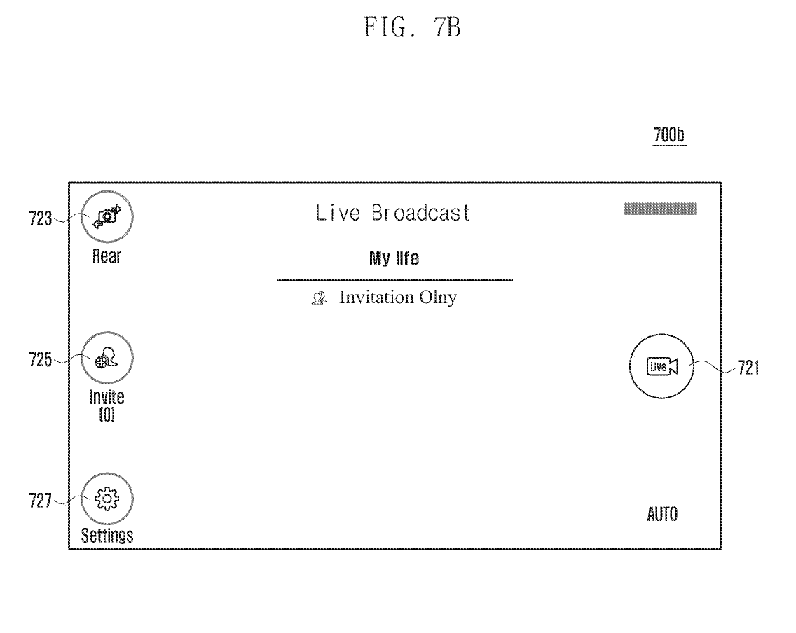

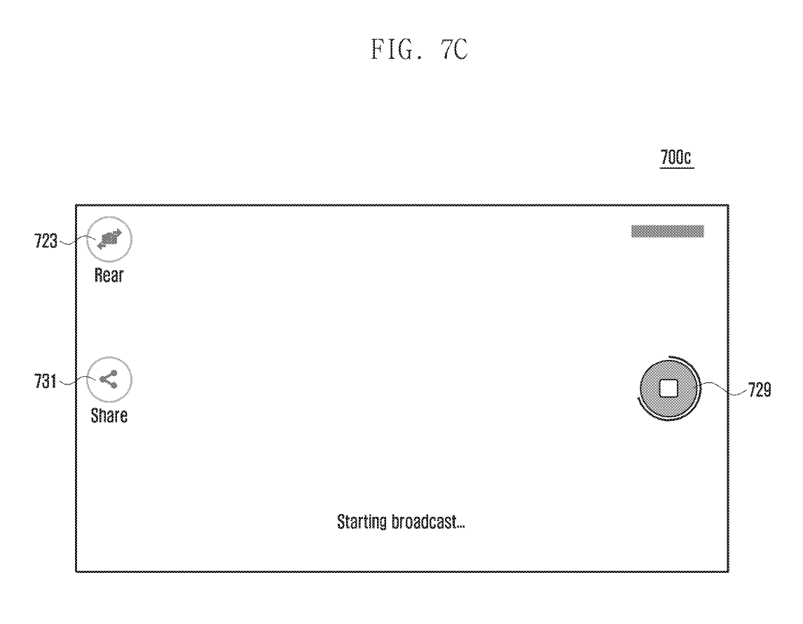

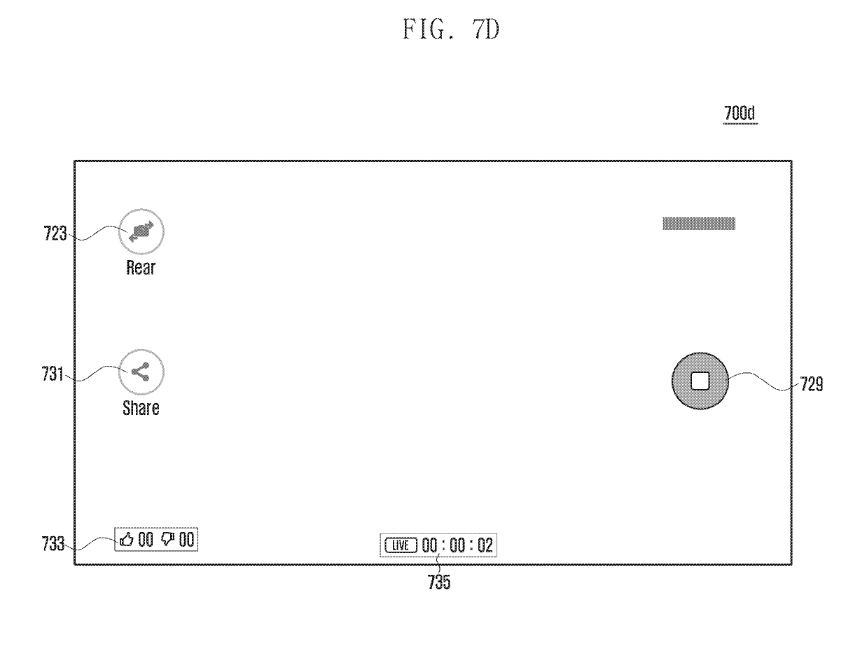

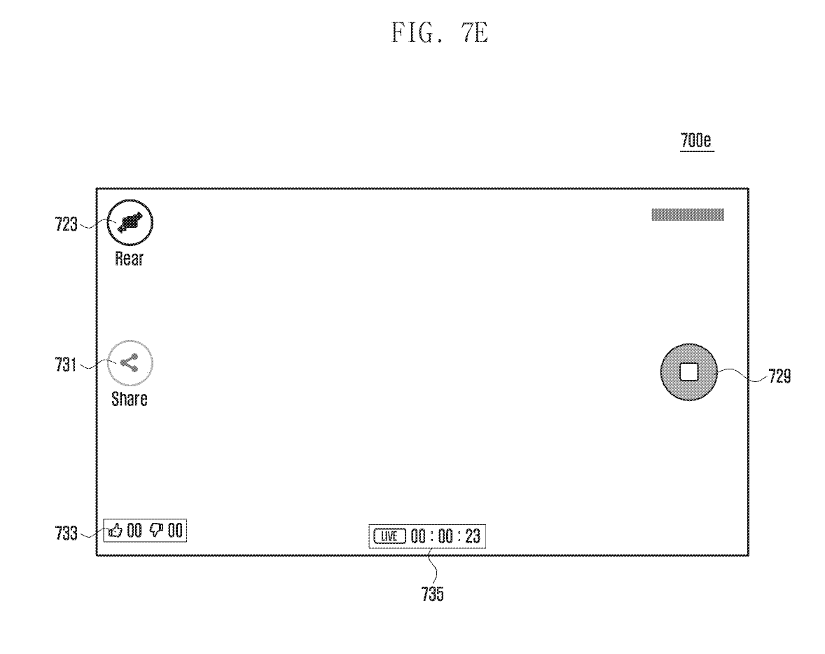

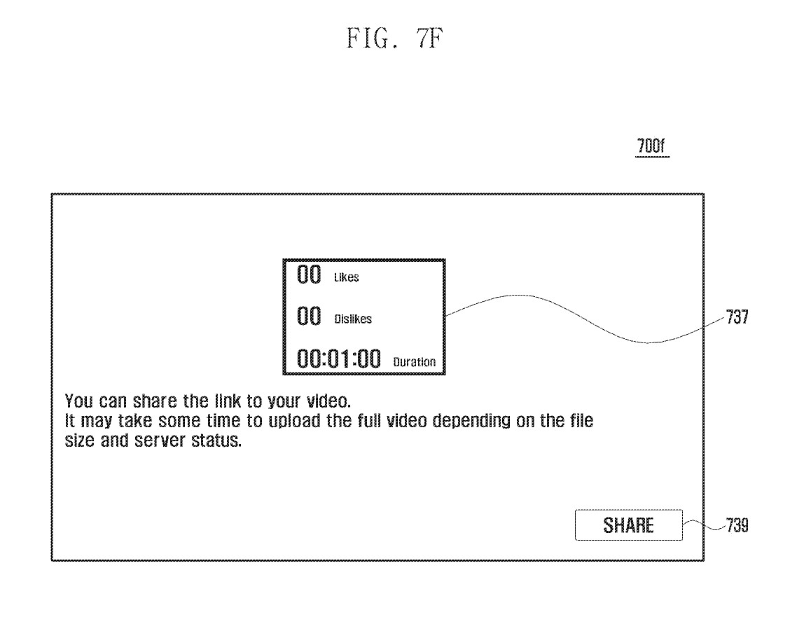

FIGS. 7A, 7B, 7C, 7D, 7E, and 7F are diagrams for describing a method for sharing content of an electronic device according to various embodiments of the present disclosure.

Referring to FIGS. 7A to 7F, illustrating screens provided from several application programs executed in the electronic device according to the present disclosure to the user. User providing screens illustrated in FIGS. 7A to 7F is for convenience of explanation and the embodiments of the present disclosure are not limited thereto and therefore the user providing screens may be variously implemented according to design specifications.

FIG. 7A illustrates a screen 700a displaying user interfaces 701 to 715 having icon forms corresponding to various functions provided from the application program to the user.

The user interface 709 that may provide the method for sharing broadcasting of an electronic device according to the embodiment of the present disclosure may include a phrase of ‘Live Broadcast’. For example, if the user clicks the user interface 709 that may provide the method for sharing broadcasting of an electronic device (that is, if the user selects a broadcasting mode), the electronic device may provide the broadcasting mode to the user. According to the embodiment, if the user touches the ‘Live broadcast’ in FIG. 7A, the image may be shared by using the designated service server and if the user performs other operations such as long-touch, in addition to the designated server, a recommended server may be displayed by a pop-up, or the like. According to the embodiment, in FIG. 7A, the recommended information depending on a voice may be provided.

According to the embodiment, the operation of selecting a broadcasting mode may include the input by the touch, the input by the voice recognition interface, and even the input by the remoted controller.

If the electronic device enters the broadcasting mode by the first input of the user, that is, the click of the user interface 709 selecting the broadcasting mode of the user, the photographing device included in the electronic device may perform the operation of preparing photographing and the electronic device may perform the operation of generating a broadcasting session.

The electronic device may provide a live view screen for confirming a screen configuration (or composition) for broadcasting. The electronic device may display a guide sentence or signal notifying that broadcasting is in preparation, a photographing means (button) notifying that the broadcasting preparation is completed, application of camera parameters for broadcasting (setting of frame rate, resolution, sensor exposure time, etc.), information (broadcasting title, etc.) associated with a session progressing broadcasting, or the like.

The electronic device may transmit a signal notifying that broadcasting is in preparation, a session generation request signal providing a broadcasting image, photographing device specifications (for example: profile), and attribute information (resolution, frame rate, etc.) to the server providing the broadcasting service and receive the information (URL address for transmitting a moving picture, URL address for listening broadcasting, etc.) associated with the broadcasting session from the server.

FIG. 7B illustrates a screen 700b provided to the user at the time of entering the broadcasting mode after the broadcasting mode is selected in FIG. 7A. Referring to FIG. 7B, the broadcasting mode may provide a photographing start function 721 instructing a photographing start through the photographing device, a rear function 723 that may change a photographing direction of the photographing device forward and backward, an invite function 725 that may share broadcasting with at least one electronic device, and a setting function 727 that may operate various settings associated with the broadcasting.

If the second input of the user is executed, that is, the user executes the photographing start function 721 instructing the photographing start, the electronic device may generate the image signal used for broadcasting and perform the operation associated with the image sharing based on the broadcasting session information.

The image signal for broadcasting generated by the photographing may be transferred to the server through the network, and at the same time may be stored in the electronic device. The image signal for storage includes information associated with broadcasting and the information associated with the broadcasting may be session information, listener information, information (network state, photographing time, etc.) associated with the broadcasting state, or the like. The image signal for storage includes the image signal for broadcasting and may be configured to include additional information that is fed back from the user. The image signal for storage may be stored in the electronic device or the server and managed.

The electronic device may perform an invite transmitting the session information (for example, URL for broadcasting connection) to at least one electronic device different from the electronic device and may transmit or receive the relevant signal to and from the server so that the elapse time of the broadcasting image provided from the server may be matched with the elapse time of the broadcasting image displayed in the electronic device.

The electronic device immediately starts broadcasting using previously set up session information between broadcasting start instruction timing and timing when broadcasting actually starts and the server and the electronic device simultaneously start a count when buffering actually starts. According to the embodiment, when the broadcasting function ends without the broadcasting start after the entry into the broadcasting mode, the electronic device may release the previously set up session and end the broadcasting.

The server may receive the image and then transmit the frame information at the timing when the broadcasting is prepared to the electronic device and the server may transmit the timer information to the electronic device. In this case, the electronic device may use the timer information based on the time synchronization to know which frame of the image is broadcast and display it.

FIG. 7C illustrates a screen 700c provided when the electronic device prepares the broadcasting start after the photographing start function 721 instructing the user to start the photographing is executed. Referring to FIG. 7C, the rear function 723, the stop function 729 that may stop the broadcasting photographing, and the share function 731 that may share the broadcasting with other electronic devices may be inactivated.

FIG. 7D illustrates a screen 700d provided by the electronic apparatus while the electronic device starts broadcasting after the broadcasting start preparation is completed in FIG. 7C and FIG. 7E illustrates a screen 700e provided by the electronic device when the broadcasting is on the air.

Referring to FIGS. 7D and 7E, the electronic device may activate the rear function 723 and the stop function 729 while starting the broadcasting in FIG. 7D and activate the share function 731 when the broadcasting is on the air in FIG. 7E.

The electronic device may provide a viewer opinion area 733 displaying a viewer's opinion in real time when the broadcasting is in progress and provide a broadcasting elapse time area 735 displaying that the broadcasting is in progress and the elapse time of the broadcasting. According to the embodiment, in addition to the viewer opinion area 733, opinions received as a text may be displayed using at least some area (or window division) of the display, or the like.

FIG. 7F illustrates a screen 700f provided by the electronic device when the broadcasting is completed. Referring to FIG. 7F, the electronic device may display the viewer's opinion about the broadcasting and provide a broadcasting complete area 737 displaying a total of broadcasting time of the broadcasting. The electronic device may provide the share function 739 to allow other electronic devices or a web page to share the broadcast image.

FIG. 8 is a diagram for describing a method for selecting at least one electronic device transmitting an invite message according to an embodiment of the present disclosure.

Referring to FIGS. 4 to 6, 7A to 7F, and 8, before the electronic device starts to photograph, at least one electronic device transmitting the invite message for sharing the broadcasting of the photographing, which may be set in advance.

If the share button providing the share function is pressed, the contact program illustrated in FIG. 8 may be automatically popped-up or temporarily displayed by the window division. Other users designated by the user input (for example, voice, touch, remote controller, or the like) among the plurality of contact information provided from the contact program may share an image. According to the embodiment, the contact program may be guided by the display and even the audio.

The electronic device may provide a search area 801 for searching for at least one electronic device transmitting the invite message among the electronic devices stored in the electronic device through an invite message transmission selection screen 800, a selection area 803 selecting at least one electronic device, a selection button 805 setting the at least one electronic device selected by the selection area 803, a cancel button 807 canceling the at least one electronic device selected by the selection area 803, and a total selection area 809 transmitting the invite message to all the electronic devices stored in the electronic device.

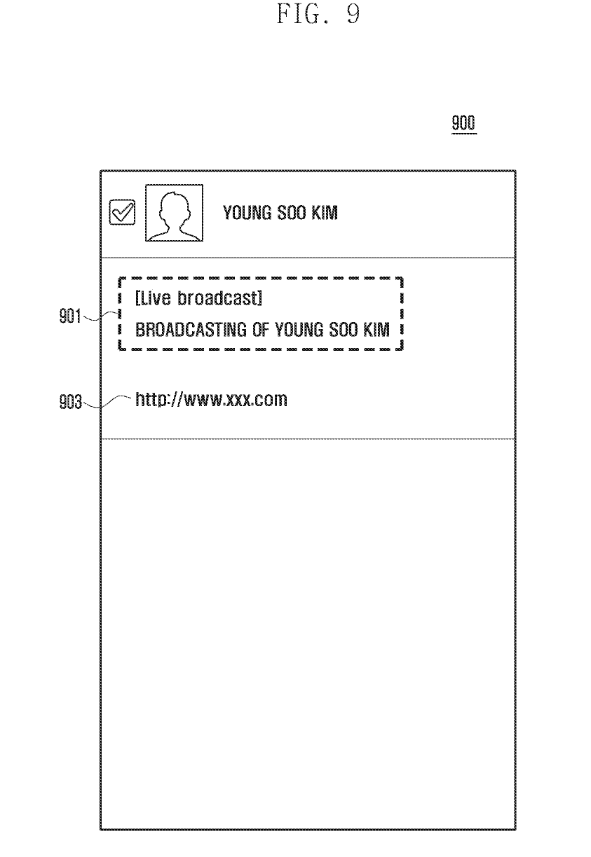

FIG. 9 is a diagram illustrating an invite message according to an embodiment of the present disclosure.

Referring to FIGS. 4, to 6, 7A to 7F to 9, the electronic device may transmit an invite message 900 in an SMS message form. The invite message 900 illustrated in FIG. 9 is a screen provided to a recipient receiving the invite message 900.

The invite message 900 may include an identification area 901 including broadcasting information (for example, ‘Live broadcast’) and user information (for example, ‘broadcasting of Young Soo Kim’) sharing broadcasting and an access address area 903 including an access URL address (for example, ‘http://www.xxx.com’) that may view the broadcasting.

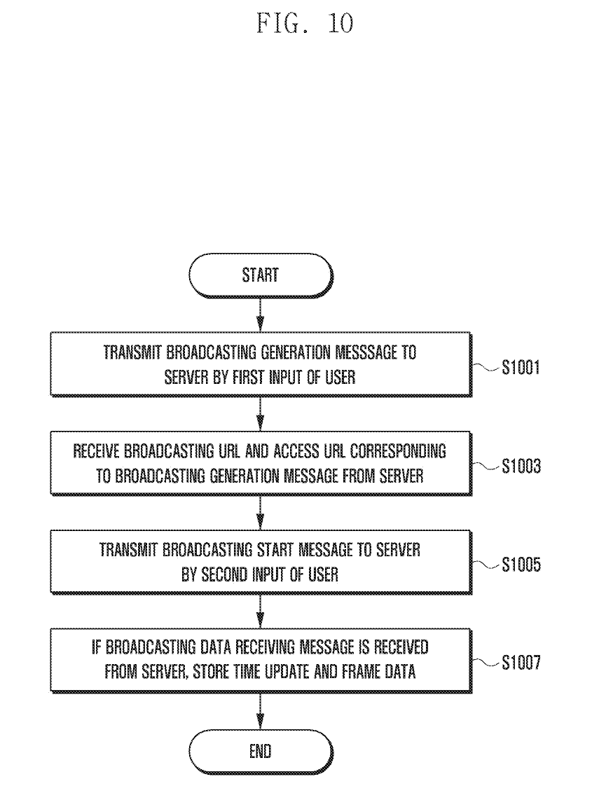

FIG. 10 is a flow chart for describing a method for sharing broadcasting of an electronic device according to an embodiment of the present disclosure.

Referring to FIGS. 4, to 6, 7A to 7F to 10, the electronic device may transmit the broadcasting generation message to the server by the first input of the user of the electronic device at operation S1001. In this case, the first input may be an input for selecting the broadcasting mode in the electronic device.

The electronic device may receive the broadcasting URL and the access URL corresponding to the broadcasting generation message from the server at operation S1003. In this case, the broadcasting URL may be an URL for broadcasting and the access URL may be an URL for accessing the server.

The electronic device may transmit the broadcasting start message to the server by the second input of the user at operation S1005. In this case, the second input may be an input instructing the photographing start by the electronic device.

If the electronic device receives the broadcasting data receiving message from the server, the electronic device may perform the time update and the storage of the frame data at operation S1007. The time update is to synchronize the server with the electronic device and is to match the elapse time of the broadcasting image provided from the server with the elapse time of the broadcasting image displayed in the electronic device. The frame data mean data generated by the photographing of the electronic device.

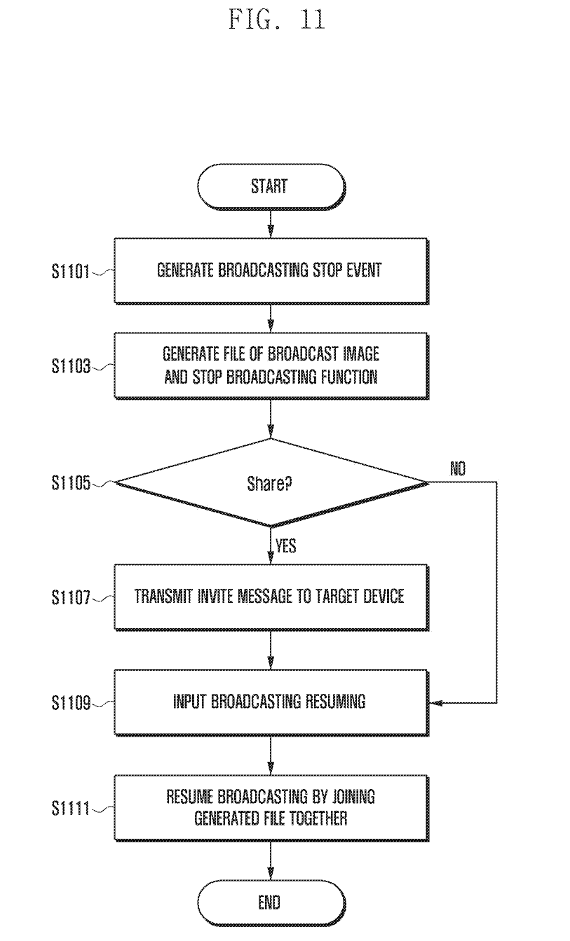

FIG. 11 is a flow chart for describing an operation of an electronic device when a broadcasting stop event according to an embodiment of the present disclosure is generated.

Referring to FIGS. 4, to 6, 7A to 7F to 11, the broadcasting stop event may be generated while the electronic device executes the broadcasting mode at operation S1101. The broadcasting stop event may mean the case in which other functions of the electronic device are executed while the broadcasting mode is being executed, like the case in which a home screen is executed while the user is executing the broadcasting mode.

If the broadcasting stop event is generated, the electronic device may generate a file of the broadcast image and stop the broadcasting function at operation S1103. When a plurality of image files is generated in one session, the electronic device may join the files together in the photographed order to generate and store one file. If the broadcasting stops within a short time (for example, less than 1 second) at which the streaming is not made, the electronic device may delete the corresponding image.

The electronic device may generate the stored image as one file in the state in which the photographing stops and may join the stored image to the existing file at the time of the following broadcasting. The electronic device may stop the transmission of the image to the server and the server may display a message notifying that the broadcasting stops.

The electronic device may determine whether the share function of the broadcasting is activated at operation S1105. According to the embodiment, if the share function is executed, the electronic device may transmit the invite message to a target device that is a target of the share function at operation S1107. The electronic device may transmit the invite message and then receive a broadcasting resuming input by the user of the electronic device at operation S1109.

According to another embodiment, if the share function is not executed, the electronic device may receive the broadcasting resuming input by the user of the electronic device at operation S1109.

The electronic device may resume the broadcasting in a manner that the image files generated by the broadcasting stop event are joined together, in response to the broadcasting resuming input at operation S1111. According to another embodiment, the electronic device may resume broadcasting while storing a new image file without joining the generated image files together, in response to the broadcasting resuming input.

According to the embodiments of the present disclosure, the electronic device and the method for providing content may link the photographing operation with the broadcasting control to simply perform the setup required to provide the content, thereby reducing the required time for the first broadcasting start.

According to the embodiments of the present disclosure, the electronic device and the method for providing content may easily share the broadcasting by the user input and adjust the synchronization by the communication with the broadcasting server.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device, comprising:
a communication transceiver;
a memory; and
a processor,
wherein the processor is configured to:
establish a connection to an external electronic device through the communication transceiver, based on at least a first input,
transmit a request for broadcasting and content to the external electronic device, based on at least a second input, and
synchronize the electronic device with the external electronic device in association with the broadcasting of the content, based on a reception of a response that at least a part of the content is received from the external electronic device.

2. The electronic device of claim 1, wherein the processor is further configured to:
transmit a broadcasting generation message to the external electronic device, as at least a part of an establishment, and
receive first link information for broadcasting and second link information for receiving the broadcasting, as at least a part of a response to the broadcasting generation message from the external electronic device.

3. The electronic device of claim 1, wherein the processor is further configured to update time information of the electronic device based on time information of the external electronic device, as at least a part of a synchronization operation.

4. The electronic device of claim 1, wherein the processor is further configured to store the content or another content associated with the content in the memory, based on at least the reception of the response.

5. The electronic device of claim 4, further comprising:
at least one input device for acquiring the content or the another content.

6. The electronic device of claim 1, wherein the processor is further configured to transmit broadcasting information corresponding to the broadcasting to another external electronic device, based on a reception of a broadcasting preparation complete message from the external electronic device.

7. The electronic device of claim 6, wherein the processor is further configured to transmit link information accessing the broadcasting to the another external electronic device, as at least a part of the broadcasting information.

8. The electronic device of claim 1, wherein the processor is further configured to:
select another external electronic device based on at least third input, and
transmit information corresponding to the broadcasting to the another external electronic device.

9. The electronic device of claim 1, wherein the reception of the response includes information corresponding to at least a part of the content that the external electronic device starts to broadcast or timer information that the external electronic device is used to broadcast.

10. The electronic device of claim 1,
wherein the electronic device includes a display, and
wherein the processor is further configured to:
receive feedback information on the content from another electronic device through the external electronic device, and
display the content, the feedback information, and a combination thereof through the display.

11. A method of operating an electronic apparatus, the method comprising:
establishing a connection to an external electronic device through a communication transceiver functionally connected to the electronic device, based on at least a first input;
transmitting a request for broadcasting and content to the external electronic device, based on at least a second input; and
synchronizing the electronic device with the external electronic device in association with the broadcasting of the content, based on a reception of a response that at least a part of the content is received from the external electronic device.

12. The method of claim 11, further comprising:
transmitting a broadcasting generation message to the external electronic device, as at least a part of the establishment of the connection; and
receiving first link information for broadcasting and second link information for receiving the broadcasting, as at least a part of a response to the broadcasting generation message from the external electronic device.

13. The method of claim 11, further comprising:
updating time information of the electronic device based on time information of the external electronic device, as at least a part of a synchronization operation.

14. The method of claim 11, further comprising:
storing the content or another content associated with the content in a memory, based on at least reception of the response.

15. The method of claim 14, further comprising:
inputting an input for acquiring the content or the another content.

16. The method of claim 11, further comprising:
transmitting broadcasting information corresponding to the broadcasting to another external electronic device, based on a reception of a broadcasting preparation complete message from the external electronic device.

17. The method of claim 16, further comprising:
transmitting link information accessing the broadcasting to the another external electronic device, as at least a part of the broadcasting information.

18. The method of claim 11, further comprising:
selecting another external electronic device based on at least third input and transmitting information corresponding to the broadcasting to the another external electronic device.

19. The method of claim 11, wherein the reception of the response includes information corresponding to at least a part of the content that the external electronic device starts to broadcast or timer information that the external electronic device is used to broadcast.

20. The method of claim 11, further comprising:
receiving feedback information on the content from another electronic device through the external electronic device; and
displaying the content, the feedback information, and a combination thereof through the display.

21. A non-transitory computer readable recording medium with an executable program stored thereon, wherein the program instructs a processor to perform the following operations:
establishing a connection to an external electronic device through a communication transceiver functionally connected to an electronic device, based on at least a first input;
transmitting a request for broadcasting and content to the external electronic device, based on at least a second input; and
synchronizing the electronic device with the external electronic device in association with the broadcasting of the content, based on a reception of a response that at least a part of the content is received from the external electronic device.
